(19) United States
(12) Patent Application Publication
(10) Pub. No.: US 2004/0218294 A1
(43) Pub. Date: Nov. 4, 2004

(54) Adjustable fastening mechanism for door mirror having an auxiliary mirror

(76) Inventor: Ming-En Chen, Yungkang City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/426,888

(22) Filed: Apr. 30, 2003

(51) Int. Cl. B60R 1/02; A47G 1/24; G02B 5/08; G02B 7/182

(52) U.S. Cl. 359/871; 359/850; 248/476

(57) ABSTRACT

A fastening mechanism for a door mirror comprises an upper arm secured to an upper bar, the upper arm including a downward loop having a first knurled surface, and a mated lower arm secured to a lower bar, the lower arm including an upward loop having a second knurled surface engaged with the first knurled surface for enabling the arms to move each other until the door mirror can be fitted in a space confined by the bars and the arms; and a trigger having a threaded pin driven through a cap and the loops into a nut of the auxiliary mirror for fastening the auxiliary mirror and the frame together. Snap fasteners of elastic straps of the lower bar are snapped onto risers of the upper bar by crossing the elastic straps over the door mirror prior to stretching the elastic straps for fastening the door mirror.

### BACKGROUND OF THE INVENTION

1. Field of the Invention

The present invention relates to a mechanism for fastening door mirror of an automobile and more particularly to a frame having a mechanism adapted to adjust the height thereof so as to fasten the door mirror and its auxiliary mirror.

2. Description of Related Art

A conventional frame for a door mirror 70 and its auxiliary mirror 60 of an automobile is shown in FIGS. 1 to 4. The frame is substantially C-shaped and comprises an upper bar 20 including two L-shaped latch members 201 extended downward from an underside, two top risers 205 each disposed above the latch member 201, and a bifurcation 204 at one end; a lower bar 30 including two top L-shaped latch members 301, two elastic straps 302 extended from undersides of the latch members 301, each elastic strap 302 having a snap fastener 303, and a bifurcation 304 at one end; an upper arm 40 including an upper connecting end piece 401, a lower connecting end piece 402, and an aperture 403 through the lower connecting end piece 402; and a lower arm 50 including an upper connecting end piece 502 mated with the lower connecting end piece 402, an aperture 503 through the upper connecting end piece 502; and a lower connecting end piece 501.

In assembly, connect the bifurcation 304 and the lower connecting end piece 501 together by means of a bolt and nut combination, connect the bifurcation 204 and the upper connecting end piece 401 together by means of another bolt and nut combination, and drive a screw 602 through the apertures 403 and 503 of the upper and the lower arms 40 and 50 into a nut 601 at a rear side of the auxiliary mirror 60 for fastening the auxiliary mirror 60 and the frame together (see FIG. 2). Next, fit the door mirror 70 in a space confined by the upper bar 20, the lower bar 30, the upper arm 40, and the lower arm 50. Finally, snap the snap fasteners 303 onto the risers 205 by crossing the elastic straps 302 over a rear surface of the door mirror 70 prior to stretching the elastic straps 302 for tightening. As an end, the door mirror 70 is secured between the upper and the lower bars 20 and 30 if the door mirror 70 is suitably sized (see FIG. 3).

However, a door mirror 70′ will not be secured if it is relatively large as shown in FIG. 4. In this case, a somewhat trapezoidal shape of the frame is formed due to pivotal movements at the fasteners. In a worst case, both the frame and the auxiliary mirror 60 may disengage from the door mirror 70′ while the automobile is driving. Thus, the need for improvement still exists.

### SUMMARY OF THE INVENTION

It is an object of the present invention to provide a fastening mechanism for a door mirror of an automobile, comprising a substantially C-shaped frame comprising an upper bar including two L-shaped first latch members extended downward from an underside, two top risers each disposed above the first latch member, and a first bifurcation at one end, the first bifurcation; a lower bar including two top L-shaped second latch members, two elastic straps extended from undersides of the second latch members, each of the elastic straps having a snap fastener, and a second bifurcation at one end; an upper arm including an upper connecting end piece threadedly secured to the first bifurcation, a first loop extended downward from an underside, a first arcuate recess at the underside, and a first knurled surface at an inner surface of the first loop; and a mated lower arm including a lower connecting end piece threadedly secured to the second bifurcation, a second loop projected upward from a top, a second arcuate recess at the top, and a second knurled surface at an inner surface of the loop, the second knurled surface being engaged with the first knurled surface wherein either the upper arm is adapted to pull up by moving the first knurled surface relative to the second knurled surface or the lower arm is adapted to pull down by moving the second knurled surface relative to the first knurled surface until the door mirror is adapted to fit in a space confined by the upper bar, the lower bar, the upper arm, and the lower arm; a cap of U section, the cap including a central aperture and a projection wherein the cap is put onto the first and the second knurled surfaces and the projection is snapped into a rear cavity of an auxiliary mirror; and a trigger member having a threaded pin wherein the threaded pin is driven through the central aperture and the first and the second loops into a rear nut of the auxiliary mirror for fastening the auxiliary mirror and the frame together, wherein the snap fasteners are snapped onto the risers by crossing the elastic straps over a rear surface of the door mirror prior to stretching the elastic straps for fastening the door mirror in the space.

The above and other objects, features and advantages of the present invention will become apparent from the following detailed description taken with the accompanying drawings.

### BRIEF DESCRIPTION OF THE DRAWINGS

FIG. 1 is an exploded view of a conventional frame to be secured to door mirror and an auxiliary mirror of an automobile;

FIG. 2 is an assembled view of FIG. 1;

FIG. 3 is a rear plan view of FIG. 2 with a suitably sized door mirror mounted in the frame;

FIG. 4 is a view similar to FIG. 3 where a relatively large door mirror is mounted in the frame;

FIG. 5 is an exploded view of a preferred embodiment of frame having a mechanism for adjustably fastening a door mirror according to the invention;

FIG. 6 is an assembled view of FIG. 5 and a door mirror to be assembled;

FIG. 7 is an assembled view of FIG. 6;

FIG. 8 is a rear plan view of FIG. 7; and

FIG. 9 is a view similar to FIG. 8 for illustrating an adjustment operation of the mechanism for being adapted to different sized door mirrors.

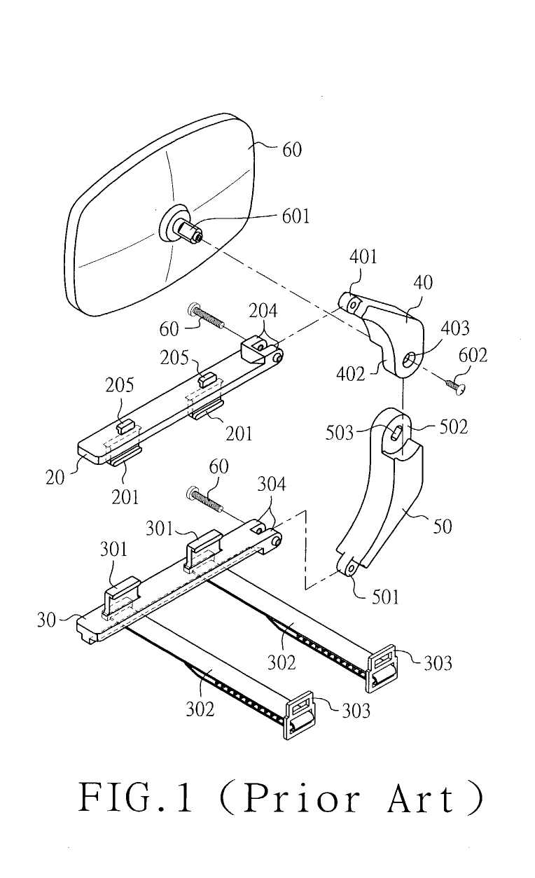

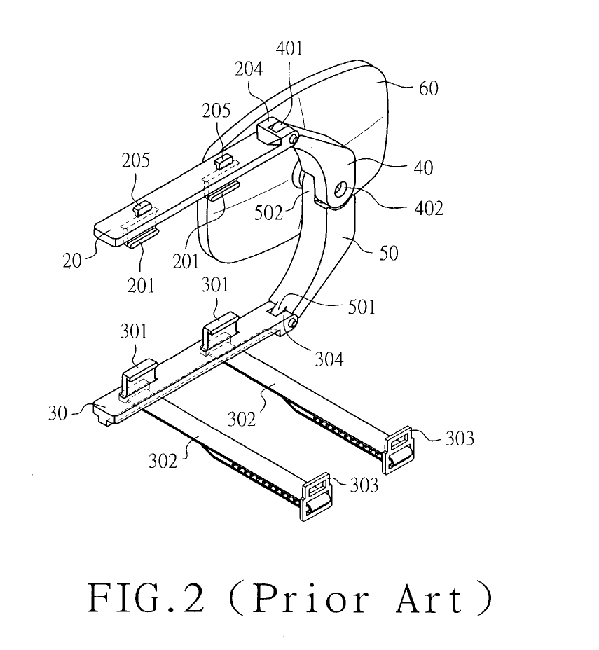

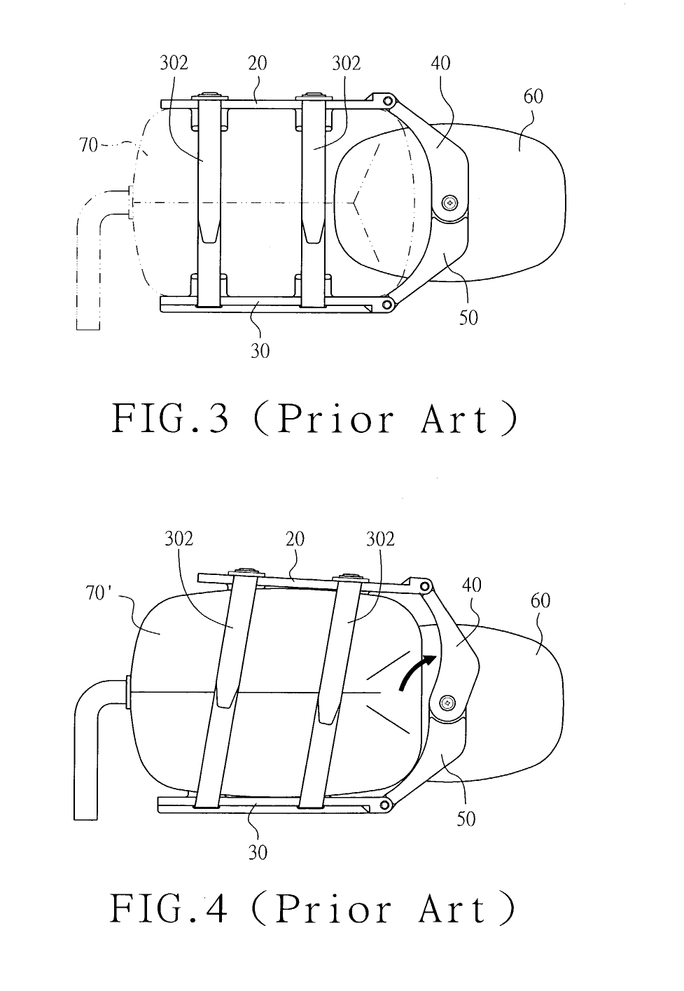

### DETAILED DESCRIPTION OF THE PREFERRED EMBODIMENTS

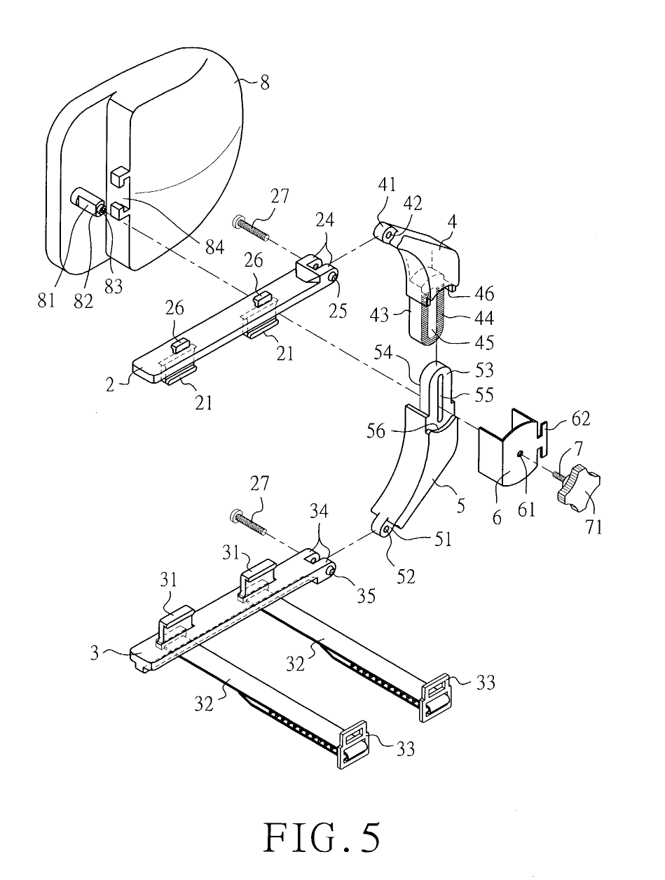

Referring to FIGS. 5, 6, and 7, a frame has an adjustable fastening mechanism for door mirror 9 having an auxiliary mirror 8 of an automobile in accordance with the invention. The frame is substantially C-shaped and comprises an upper bar 2 including two L-shaped latch members 21 extended downward from an underside, two top risers 26 each disposed above the latch member 21, and a bifurcation 24 at one end, the bifurcation 24 having a transverse aperture 25; a lower bar 3 including two top L-shaped latch members 31, two elastic straps 32 extended from undersides of the latch members 31, each elastic strap 32 having a snap fastener 33, and a bifurcation 34 at one end, the bifurcation 34 having a transverse aperture 35; an upper arm 4 including an upper connecting end piece 41 having an aperture 42, a loop 43 extended downward from an underside, a channel 45 formed by the loop 43, an arcuate recess 46 at the underside, and a knurled surface 44 at an inner surface of the loop 43; a mated lower arm 5 including a lower connecting end piece 51 having an aperture 52, a loop 53 projected upward from a top, a channel 55 formed by the loop 53, an arcuate recess 56 at the top, and a knurled surface 54 at an inner surface of the loop 53; a cap 6 of U section, the cap 6 including a central aperture 61 and a T-shaped projection 62; and a trigger member 7 having a knob 71. Also, the auxiliary mirror 8 at its rear side comprises a nut 82 having a flat 81 on its surface and a threaded hole 83, and a T-shaped cavity 84 adjacent the nut 82.

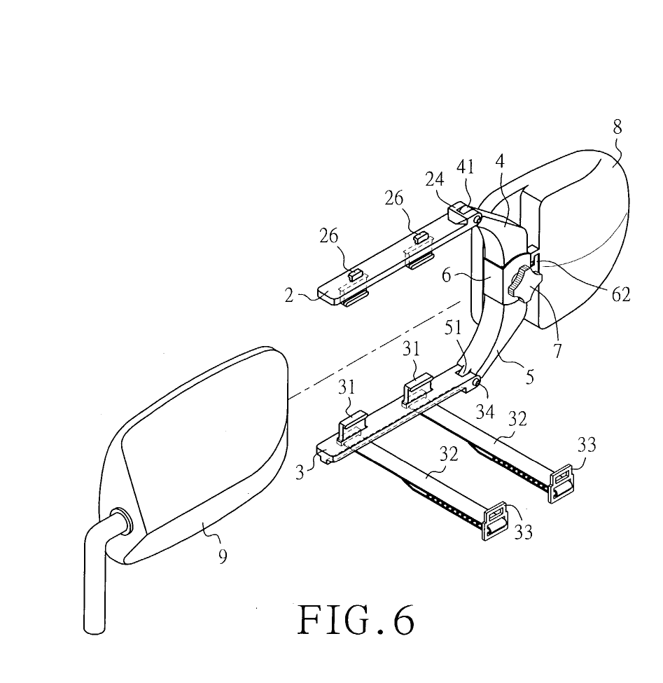

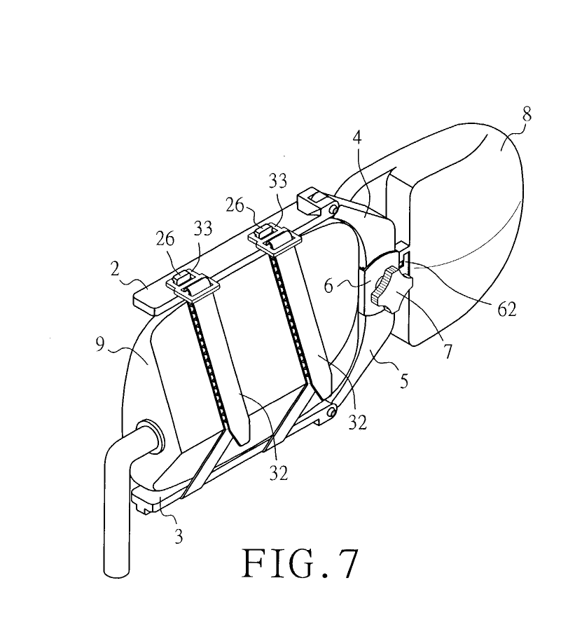

In assembly, connect the bifurcation 34 and the lower connecting end piece 51 together by fastening a bolt and nut combination 27 through the apertures 35 and 52, connect the bifurcation 24 and the upper connecting end piece 41 together by fastening another bolt and nut combination 27 through the apertures 25 and 42, assemble the upper and the lower arms 4 and 5 together by engaging the knurled surface 44 with the knurled surface 54 with a top of the loop 53 urged against the recess 46 and an underside of the loop 43 urged against the recess 56 respectively in an exemplary example, put the cap 6 onto the knurled surfaces 54 and 44 for covering with the T-shaped projection 62 snapped into the T-shaped cavity 84, and drive a screw portion of the trigger member 7 through the aperture 61 and the channels 55 and 45 into the nut 83 for fastening the auxiliary mirror 8 and the frame together (see FIG. 6). Next, fit the door mirror 9 in a space confined by the upper bar 2, the lower bar 3, the upper arm 4, and the lower arm 5. Finally, snap the snap fasteners 33 onto the risers 26 by crossing the elastic straps 32 over a rear surface of the door mirror 9 prior to stretching the elastic straps 32 for tightening. As an end, the door mirror 9 is secured between the upper and the lower bars 2 and 3 (see FIG. 7).

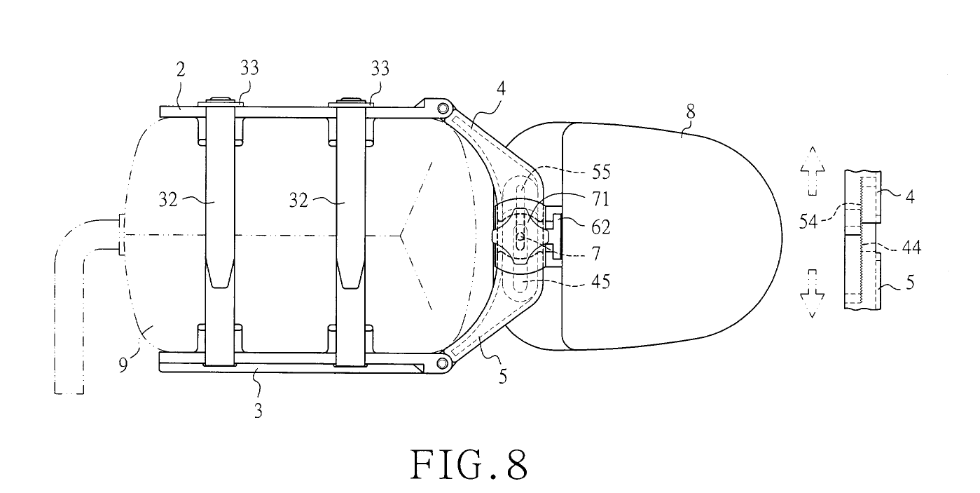

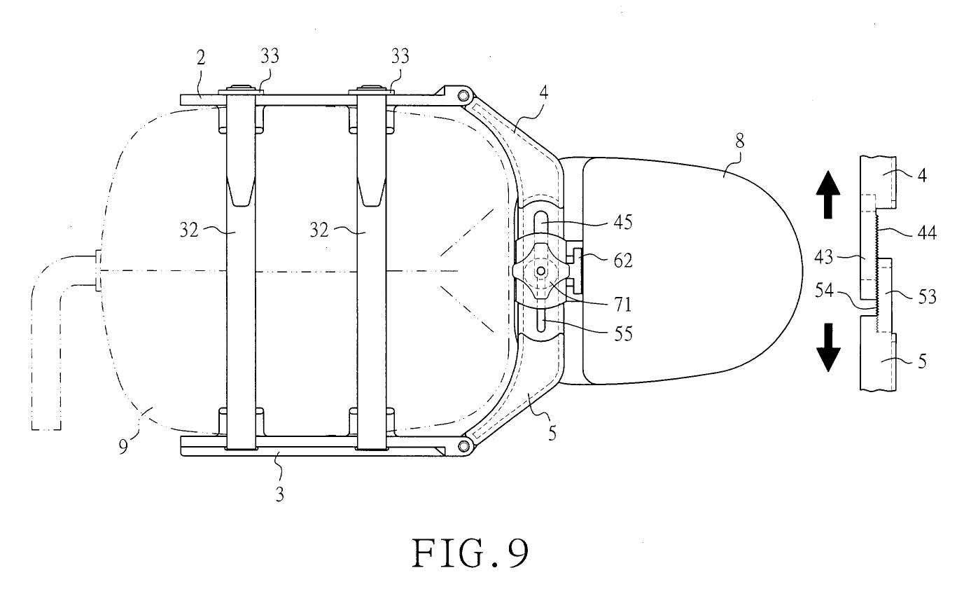

Referring to FIGS. 8 and 9, an adjustment operation of the mechanism for being adapted to different sized door mirrors 9 will be described. In a case that the door mirror 9 is relatively large a user can first detach the cap 6 and the trigger member 7 from the frame. Next, pull the upper arm 4 a suitable distance from the lower arm 5 by moving the knurled surface 44 relative to the knurled surface 54 or vice versa until height of the door mirror 9 is about equal to a distance between the upper and the lower bars 2 and 3. Next, put the cap 6 onto the knurled surfaces 54 and 44 for covering with the T-shaped projection 62 snapped into the T-shaped cavity 84, and drive the screw portion of the trigger member 7 through the aperture 61 and the channels 55 and 45 into the nut 83 for fastening the auxiliary mirror 8 and the frame together (see FIG. 6). Next, fit the door mirror 9 in a space confined by the upper bar 2, the lower bar 3, the upper arm 4, and the lower arm 5. Finally, snap the snap fasteners 33 onto the risers 26 by crossing the elastic straps 32 over the rear surface of the door mirror 9 prior to stretching the elastic straps 32. As an end, the door mirror 9 is secured between the upper and the lower bars 2 and 3. In another case that the door mirror 9 is relatively small a similar adjustment operation can be performed. In brief, the door mirror 9 can be reliably secured between the upper and the lower bars 2 and 3 by adjusting the above mechanism.

While the invention herein disclosed has been described by means of specific embodiments, numerous modifications and variations could be made thereto by those skilled in the art without departing from the scope and spirit of the invention set forth in the claims.

What is claimed is:

1. A fastening mechanism for a door mirror of an automobile, comprising:
a substantially C-shaped frame comprising an upper bar including two L-shaped first latch members extended downward from an underside, two top risers each disposed above the first latch member, and a first bifurcation at one end, the first bifurcation; a lower bar including two top L-shaped second latch members, two elastic straps extended from undersides of the second latch members, each of the elastic straps having a snap fastener, and a second bifurcation at one end; an upper arm including an upper connecting end piece threadedly secured to the first bifurcation, a first loop extended downward from an underside, a first arcuate recess at the underside, and a first knurled surface at an inner surface of the first loop; and a mated lower arm including a lower connecting end piece threadedly secured to the second bifurcation, a second loop projected upward from a top, a second arcuate recess at the top, and a second knurled surface at an inner surface of the loop, the second knurled surface being engaged with the first knurled surface wherein either the upper arm is adapted to pull up by moving the first knurled surface relative to the second knurled surface or the lower arm is adapted to pull down by moving the second knurled surface relative to the first knurled surface until the door mirror is adapted to fit in a space confined by the upper bar, the lower bar, the upper arm, and the lower arm;
a cap of U section, the cap including a central aperture and a projection wherein the cap is put onto the first and the second knurled surfaces and the projection is snapped into a rear cavity of an auxiliary mirror; and
a trigger member having a threaded pin wherein the threaded pin is driven through the central aperture and the first and the second loops into a rear nut of the auxiliary mirror for fastening the auxiliary mirror and the frame together,
wherein the snap fasteners are snapped onto the risers by crossing the elastic straps over a rear surface of the door mirror prior to stretching the elastic straps for fastening the door mirror in the space.
